(19) United States
(12) Patent Application Publication
(10) Pub. No.: US 2016/0303836 A1
(43) Pub. Date: Oct. 20, 2016

(54) HEAT BUILD-UP AND COLOR FADE RESISTANT VINYL EXTRUDATE

(71) Applicant: Ply Gem Industries, Inc., Cary, NC (US)

(72) Inventors: Danny R. Parks, Blue Springs, MO (US); Eric B. Dickey, Overland Park, KS (US); Leland F. Harris, Plattsburg, MO (US)

(21) Appl. No.: 14/691,166

(22) Filed: Apr. 20, 2015

(51) Int. Cl. B32B 27/30; B32B 27/20; B32B 27/08

(52) U.S. Cl. CPC B32B 27/304; B32B 27/08; B32B 27/20; B32B 2250/24; B32B 2307/306; B32B 2307/4026; B32B 2307/416

(57) ABSTRACT

A polymer extrudate panel resistant to heat build-up and color fading comprising a top polymer layer in addition to an infrared light reflective capstock layer disposed beneath the top layer. The polymer extrudate panel further comprises a substrate layer disposed beneath the capstock layer wherein the extrudate exhibits a predicted heat build-up of less than about 50° F. for a panel with L* value of less than 40.

### FIELD OF THE DISCLOSURE

This disclosure relates in general to a heat buildup resistant and color fade resistant polymer extrudate panel comprising a top polymer layer and an infrared light reflective capstock layer disposed beneath the top layer. The panel further includes a substrate layer disposed beneath the capstock layer.

### BACKGROUND

Vinyl siding has a very large market penetration and has been the most used siding product on new single-family homes in the U.S. every year since 1994. It was applied to roughly 35% of all new homes built during that time frame. The majority of new vinyl sided homes are in the south (40%), mid-west (35%), and northeast (19%) (U.S. Census Bureau 2009). Based on sales data and projections from 1999 to 2019, approximately 45% of residential vinyl siding is, or will be, used in the new construction market; the remainder will be used for retrofits and repairs (Freedonia Group, Inc. 2009). Principia Residential Siding & Trim Report (Principia Consulting LLC) forecasts North American vinyl siding demand to be 34% of all cladding types used for new construction and repair & remodel by 2016. Key markets are expected to continue showing strong demand for vinyl siding versus other cladding types (e.g. Mid-Atlantic region—44% vinyl siding demand, East North Central region—43% and New England region 42%).

Two problems that continue to challenge the vinyl siding industry are (a) color fade due to exposure to intense sunlight over time and (b) thermal distortion due not only from direct warming by the sun but also due to reflection of sunlight from adjacent glass surfaces that concentrate the heat in a localized fashion and can substantially degrade the vinyl siding.

Consumers value the ability of vinyl siding to maintain its appearance after years of exposure to the elements and, more specifically, its ability to resist objectionable color change over its expected lifetime. ASTM D6864 titled Specification for Color and Appearance Retention of Solid Colored Plastic Siding Products provides a rigorous method for verifying that the original color is retained within reasonable time limits. This standard provides a standardized and consistent method of measuring and evaluating the degree of color change occurring in siding products after a period of outdoor exposure. It includes limits on the acceptable amount of color change based on perceptual studies of color change tolerances for different classifications, or regions, of colors.

PVC products for many years were available only in white plus shades of beige and gray. Siding panels and window profiles in dark colors, such as “Hunter Green” and “Dark Red,” have long been demanded in the industry. Still, there is the significant issue of heat build-up, which largely accounts for the relative lack of dark colors in PVC siding and other products formed of extrudates.

When referring to dark colors herein, the reference is generally to colors with an L* value between 13 and 40 per ASTM 4726-02. It is well known in the vinyl siding industry that PVC siding will fail in unacceptably high numbers, exhibiting symptoms such as buckling, warping and sagging, if the siding become too hot. The environmental factors typically causing a siding panel to warm is a high ambient air temperature in addition to visible light and near infrared solar radiation. ASTM standards D4803 titled, Predicted Heat Build-Up, and WK47658 titled, Standard test method for using reflectance spectra to produce an index of temperature rise in polymeric siding, are good predictors of product performance related to heat induced PVC siding failure.

### SUMMARY

These and other objects of the present invention, which will become apparent hereinafter, are achieved by providing a heat build-up resistant and a fade resistant extrudate of the type described.

It is therefore an object of the disclosed technology to provide a heat build-up resistant extrudate comprised of a top layer polymer blended with at least one additive, a middle capstock layer disposed beneath the polymer layer and a substrate disposed beneath the capstock layer. The extrudate further exhibiting a predicted heat build-up as measured according to ASTM D4803 or ASTM WK47658, of less than about 50° F. This ASTM test method covers prediction of the heat buildup in rigid and flexible PVC building products above ambient air temperature, relative to black, which occurs due to absorption of the sun's energy.

These, together with other aspects of the disclosed technology, along with the various features of novelty that characterize the technology, are pointed out with particularity in the claims annexed hereto and form a part of this disclosed technology. For a better understanding of the disclosed technology, its operating advantages and the specific objects attained by its uses, reference should be made to the accompanying drawings and descriptive matter in which there are illustrated exemplary embodiments of the disclosed technology.

### BRIEF DESCRIPTION OF THE DRAWINGS

Illustrative embodiments of the disclosed technology are described in detail below with reference to the attached drawing figures, which are incorporated by reference herein and wherein:

FIG. 1 is a side elevation view of insulating glass lites in an insulating glass unit at equilibrium and evenly spaced apart;

FIG. 2 is a side elevation view of insulating glass lites in an insulating glass unit flexing outwardly due to temperature and pressure changes in the environment;

FIG. 3 is a side elevation view of insulating glass lites in an insulating glass unit flexing inwardly due to temperature and pressure changes in the environment;

FIG. 4 is an elevation view of an opposite wall condition detailing how the sun's energy is reflected off an insulating glass lite onto vinyl siding installed on an opposing wall of a neighboring structure;

FIG. 5 is a plan view illustrating how a vinyl siding clad inside corner can be exposed to solar energy reflected from an insulating glass lite in an insulating glass unit;

FIG. 6 is an isometric view of an exemplary embodiment of an extrudate siding panel; and

FIG. 7 is a cross sectional view taken along line 7-7 of FIG. 6 of a first exemplary embodiment of a vinyl siding panel detailing the disclosed three layer technology.

### DETAILED DESCRIPTION

COLOR FADE OF VINYL SIDING: With many hundreds of vinyl siding colors available to consumers, colors along with style and cost are the most discussed consideration in vinyl siding selection. Most manufacturers of vinyl siding include a color retention certification that allows the manufacturer to verify that their solid and multi-hued colors meet or exceed the requirements of ASTM D6864 or D7251, the standards for solid color or multi-hued vinyl siding color retention.

The CIELAB is a color scale based on the Opponent-Color Theory. The L*, a*, b* color space includes all perceivable colors. One of the most important attributes of the L* a*b* model is device independence which means that the colors are defined independent of their nature of creation or the device they are displayed on.

The CIELAB is a color scale based on the Opponent-Color Theory. This theory assumes that the receptors in the human eye perceive color as the following pairs of opposites.

L* scale: light vs. dark where a low number (0-50) indicates dark and a high number (51-100) indicates light.

a* scale: Red vs. green where a positive number indicates red and a negative number indicates green.

b* scale: Yellow vs. blue where a positive number indicates yellow and a negative number indicates blue.

The delta values (ΔL, Δa, and Δb) indicate how much a standard and sample differ from one another in L*, a* and b*. The ΔL, Δa, and Δb values are often used for quality control or formula adjustment. Delta values that are out of tolerance indicate that there is too much difference between the standard and the sample, such as in evaluating the fade of a polymer object after years of exposure to sunlight and the environment. The type of correction needed may be determined by which delta value is out of tolerance. For example, if Δa is out of tolerance, the redness/greenness needs to be adjusted. Whether the sample is more red or green than the standard is indicated by the sign of the delta value. For example, if Δa is positive, the sample is redder than the standard. The total color difference, ΔE, may also be calculated. ΔE is a single value that takes into account the difference between the L*, a* and b* of the sample and the standard. It does not indicate which parameter is out of tolerance if ΔE is out of tolerance. The CIE L*, a*, b* color scale can be used on any object, including vinyl siding, whose color may be measured.

Vinyl siding manufacturers currently define excess fade, due to normal weathering (exposure to sunlight, and extremes of weather and atmosphere which will cause any colored surface to gradually fade, chalk, or accumulate dirt or stains), as a change in color, calculated according to ASTM D2244. Under this standard, a color spectrophotometer is used to measure the CIE L*, a*, and b* color values for test specimens. After the spectrometer is calibrated using a white tile reflectance standard, a measurement is made with a color standard tile for gage, reliability, and reproducibility. Four color measurements are taken on each test specimen in an area free from defects. The average value for the four measurements is then used to determine if the total color change, ΔE, is greater than the manufacturer's established color fade value. The process of assessing the color change is done in accordance with ASTM standard D6864. The ΔE is typically referred to as color units or Hunter units.

THERMAL DISTORTION OF VINYL SIDING: Vinyl siding is often selected as an exterior cladding material because of its low maintenance and low cost qualities. However, there are several considerations that need to be taken into account when using vinyl siding products because vinyl siding products undergo heat deflection in the range of 142°-192° F. with an average distortion temperature of 166° F. according to a Lawrence Berkley National Laboratory Research Report titled “Research Needs: Glass Solar Reflectance and Vinyl Siding”; R. Hart, et. al, July 2011. Vinyl siding is available in a variety of colors with related solar absorptance levels (a measure of the proportion of solar radiation a body absorbs). In general, the darker the color, the more absorptive the siding. The absorptance values can range from 20% to 80%. The more absorptive the vinyl siding, the faster its temperature will increase when exposed to thermal energy or solar irradiance. There is a direct correlation between vinyl siding solar absorptance and the heating of the vinyl siding above the ambient air temperature.

The majority, approximately 51%, of solar energy to which exterior building materials are typically exposed is in the infrared (IR) spectrum (ASTM 1998). Because of this, absorptance in the IR spectrum has the greatest impact on the quantity of solar energy a material absorbs. Carbon black, a common black pigment, absorbs approximately 95% of solar IR, therefore alternative pigments with more favorable reflectance in the IR range are almost always used in vinyl siding. For comparison, titanium dioxide, an often-used white pigment, absorbs approximately 20% of solar IR. As noted above, darker colors will absorb more energy and have greater heat build-up. However, even for two materials with the same apparent color, the heat build-up may vary because of the specific pigment system used and its absorptance in the IR range.

With no sun on the siding, the vinyl siding temperature is the same as the ambient air temperature. At 20% and 40% solar absorptance, vinyl siding is able to withstand greater exposure to solar irradiance before distorting, than darker vinyl siding at 60% and 80% solar absorptance. The maximum direct solar irradiance normal to the sun for a given location, on a clear day, with the sun highest in sky, is approximately 1000 W/m². This level of solar irradiance is often referred to as “one sun”. However, the orientation of the sun relative to the siding will lessen the intensity of the solar irradiance due to the sun's angle of incidence. The solar irradiance experienced by the siding will vary with location, time of day and weather conditions, but a typical “corrected one sun” value for the irradiance on a vertical wall, is approximately 750 W/m^{2.}

Current testing requirements for the vinyl siding industry are per ASTM D3679, Standard Specification for Rigid Poly (Vinyl Chloride) (PVC) Siding. Vinyl siding meeting this standard is verified to meet weathering performance, color, gloss, windload resistance (withstanding wind pressures of at least 110 mph), surface distortion, impact resistance, flammability, heat shrinkage, linear expansion, camber, length, width and thickness. However, ASTM D3679 has a maximum test level of 120° F. This is significantly below the temperature that vinyl siding can experience when exposed to direct sunlight. In ASTM D4803-10, Standard Test Method for Predicting Heat Buildup in PVC Building Products and ASTM WK47658 Standard Test method for Using Reflectance Spectra to Produce an Index of Temperature Rise in Polymeric Siding, it is recognized that the sun can cause PVC building products to distort. Under section 5.1 Significance and Use, ASTM standard D4803-10 provides that heat buildup in PVC exterior building products due to absorption of the energy from the sun may lead to distortion problems. Heat build-up is affected by the color, emittance, absorptance, and reflectance of a product.

The heat build-up due to the absorption of solar energy in materials for outdoor application can be measured based upon data obtained by experimentally determining the total solar reflectance (TSR) and the temperature rise above ambient temperature under an ultraviolet heat lamp, relative to carbon black according to ASTM D4803 and ASTM WK47658 Standard Test method for Using Reflectance Spectra to Produce an Index of Temperature Rise in Polymeric Siding.

The challenges associated with darker siding color and distortion have only become more pronounced with the advent of Energy efficient low emissivity (“Low-E”) units comprised of two lites of glass separated by a spacer bar. Frequently, one lite of glass is coated with a Low-E coating that serves two functions: 1) reflects out the sun's short wave infrared energy in summer; and 2) reflect and keep in the home's long wave infrared energy in winter. These windows work by reflecting a greater percentage of sunlight, especially in the infrared “heat” wavelengths. Insulating glass units are made of two or more panes of glass that are hermetically sealed at the edge, trapping an insulating layer of air or other gas in between. When the pressure between the panes of glass is different from the atmospheric pressure, the glass is designed to bend slightly. When the glass deflects inward, this creates a concave reflective surface that concentrates the reflected beam of sunlight. Objects in the path of the beam may be subjected to temperatures well in excess of those from normal exposure to the sun.

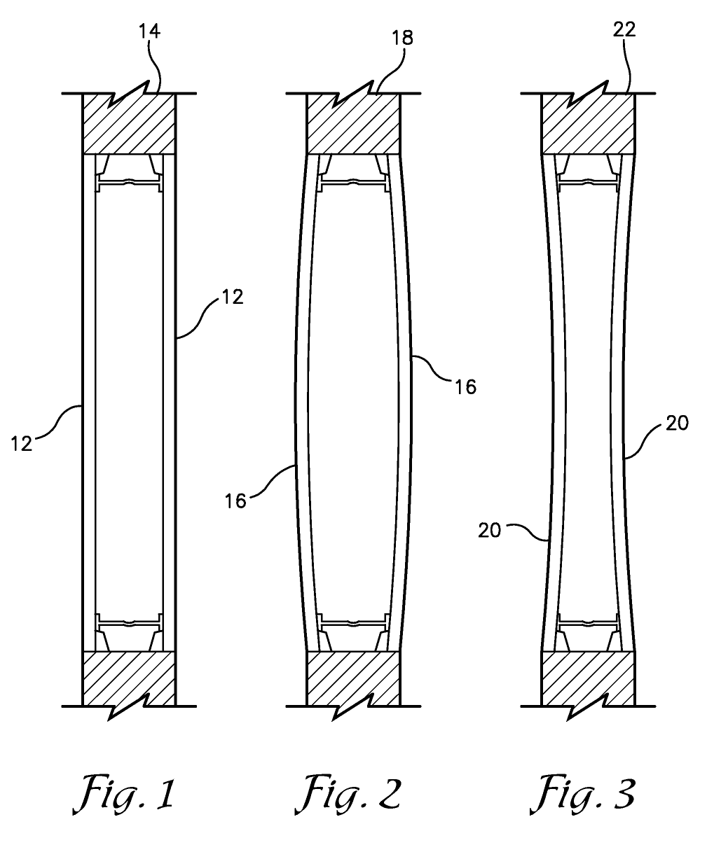

FIG. 1 depicts an insulating glass lites 12 in an insulating glass unit 14 where the glass lites 12 are equidistant from one another. FIG. 2 depicts the insulating glass lites 16 in an insulating glass unit 18 where the glass lites 16 are bowing away from one another. FIG. 3 depicts the insulating glass lites 20 in an insulating glass unit 22 where the glass lites 20 are bowing inward toward one another.

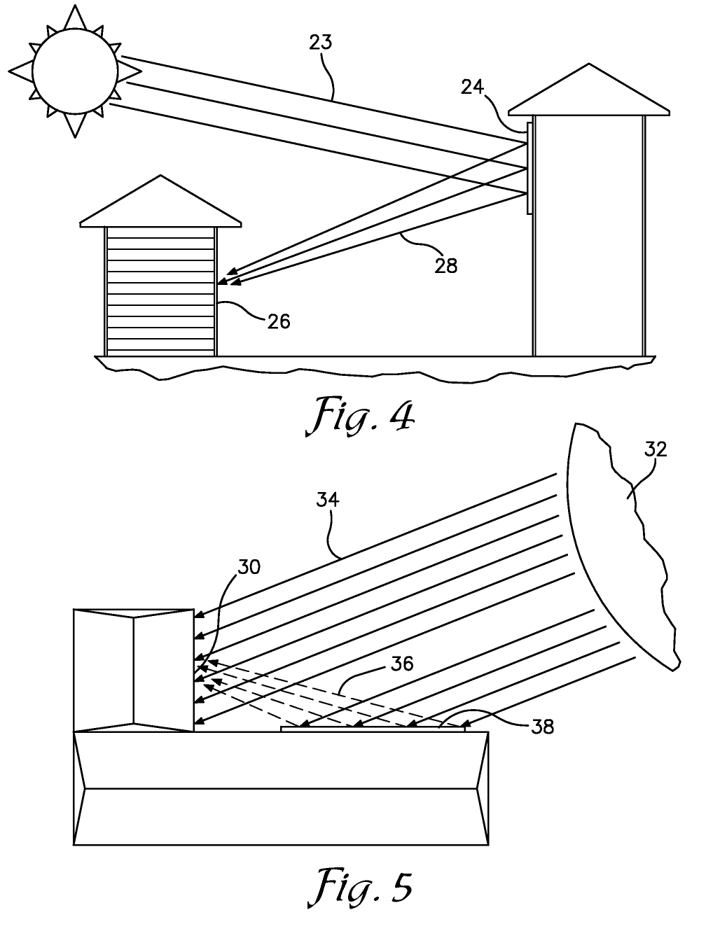

The dynamic flexing of insulating glass lites 16, 20 that may be seen in an insulating glass unit due to temperature and pressure changes in the environment. Most instances of vinyl siding distortion fall into one of two categories: opposite wall condition and inside corner condition. Opposite Wall Condition is illustrated in FIG. 4 and reveals how the sun's energy 23 can be reflected off a window 24 or door onto vinyl siding installed on an opposing wall 26 of a neighboring structure (“opposite wall condition”). In this scenario, the solar energy 28 is reflecting off the glass of the insulating glass unit 24. When solar energy is reflected off of an insulating glass unit with no or minimal deflection, the resulting reflection stays in relatively parallel lines and does not concentrate. As the amount of deflection increases, as seen with the glass lites in FIG. 3, the reflected energy becomes more concentrated, resulting in higher temperatures where the light rays converge.

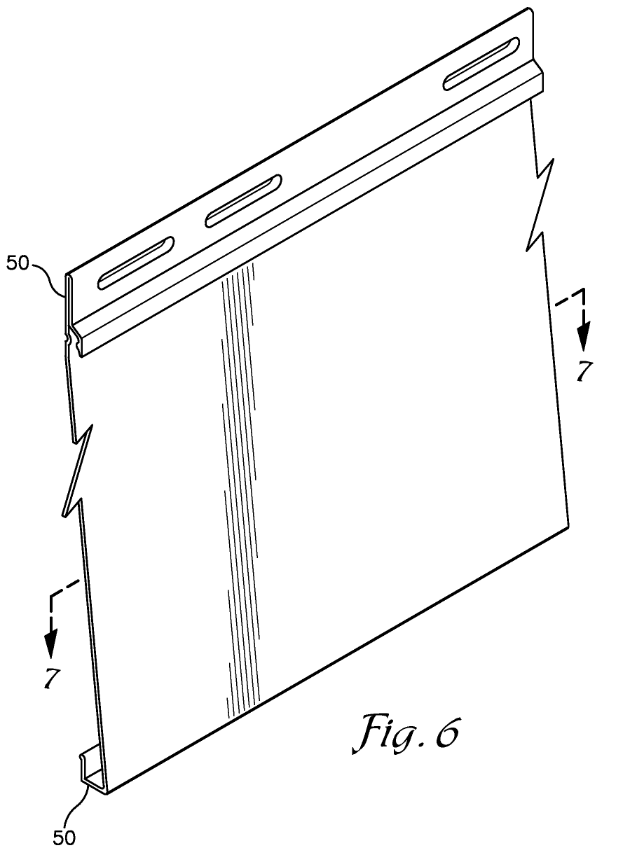

FIG. 5 illustrates how a vinyl siding clad inside corner 30 can be exposed to solar energy. In this situation, the vinyl siding 30 receives direct exposure to the sun's 32 energy 34. In addition, sun light 36 may reflect off an adjacent glass product 38 at a grazing angle onto the vinyl siding 30. This results in a near doubling of the solar exposure on the vinyl siding. The inside corner condition occurs when the sun's rays reflect off a glass product at a very small grazing angle. In this scenario, the solar energy is generally reflecting off the first surface (i.e. outer surface of the exterior lite of glass) of an insulating glass unit 38.

Vinyl siding is generally manufactured by co-extrusion. Two layers of PVC are laid down in a continuous extrusion process; the top layer is weatherable capstock, which comprises about a third of the siding thickness. This capstock includes about 10% titanium dioxide, which, as discussed above, is a pigment and provides resistance to breakdown from UV light. As discussed above, vinyl siding, like paint, will inevitably fade over time, but the fade rate is somewhat slower with vinyl, and in any house cladding (vinyl, paint or others) the intensity of the color is in direct correlation to the rate of fade. For example, two currently popular colors are “barn red” and “clay”. In reaction to sunlight, the barn red will fade faster than the very neutral clay color whether paint, vinyl siding or other composition. The lower layer, known as substrate, is typically about 15% ground limestone (which is largely calcium carbonate). The limestone reduces cost, and also balances the titanium dioxide, keeping both extrusion streams equally fluid during manufacturing. A small quantity of tin mercaptan or butadiene is added as a stabilizer to chemically tie up any hydrochloric acid that is released into the PVC material as the siding ages. Lubricants are also added to aid in the manufacturing process.

The disclosed distortion resistant siding technology utilizes polyvinylidene fluoride, or polyvinylidene difluoride (PVDF), a non-reactive and pure thermoplastic fluoropolymer produced by the polymerization of vinylidene difluoride. PVDF is a specialty plastic material in the fluoropolymer family; it is used generally in applications requiring the highest purity, strength, and resistance to solvents, acids, bases and heat and low smoke generation during a fire event. Compared to other fluoropolymers, it has an easier melt process because of its relatively low melting point of around 177° C. PVDF is a fluorocarbon and is classified as “Self Extinguishing, Group 1” by Underwriters' Laboratories, Inc. The key benefits of the material for purposes of a vinyl siding application are its: low weight, low thermal conductivity, high chemical corrosion resistance, heat resistance, mechanical strength and toughness, high abrasion resistance, resistant to most chemicals and solvents, the material is very hydrophilic resistant and is unaffected by long-term exposure to ultraviolet radiation.

FIG. 6 is an exemplary embodiment of a vinyl siding panel 50 utilizing the disclosed technology. Alternative embodiments of the extrudate panel will utilize three layer and two layer configurations depending upon the particular needs of the end user.

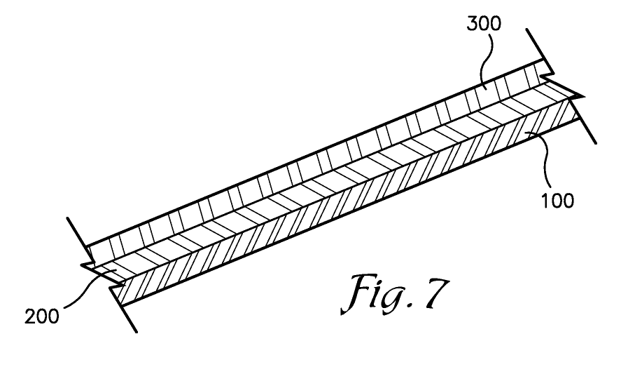

In a first embodiment of a cross section along line A-A of extrudate panel 50 as illustrated at FIG. 7, the disclosed color fade and thermal distortion resistant siding preferably utilizes a top, or front face, layer 100 of PVDF. The top polymer face layer 100 preferably has a thickness in the range of 0.0005 inches to 0.001 inches. In an alternative embodiment, the first layer may be comprised of a polymer selected from the group consisting of acrylic, acrylonitrile styrene acetate, polyvinyl chloride and a polymer film.

In addition to the top layer, the siding utilizes a capstock layer 200 disposed beneath, and thermally bonded to, the PVDF polymer layer 100. The capstock layer 200 comprises a polymer selected from the group of polyvinyl chloride, polypropylene, polyethylene polymers and copolymers and mixtures thereof. The at least one additive is chosen from a color pigment, a white pigment, a metallic pigment, or a combination of two or more of the additives. The white pigment is preferably a titanium dioxide (TiO₂) pigment. In addition, additives such as lubricants, tin stabilizers, impact modifiers, polyvinyl chloride and mixtures thereof may be incorporated into the mixture. The addition of the TiO₂ facilitates a total solar reflectance of at least 30% which reduces solar energy absorption. The solar reflectance is generally measured using a spectrophotometer. The capstock layer 200 preferably has a thickness in the range of from 0.003 to 0.004 inches

The third and final layer of the disclosed color fade and thermal distortion resistant siding disposed beneath the capstock layer 200 is a substrate layer 300. The substrate, or back, layer 300 is preferably comprised of approximately 80% polyvinyl chloride with color pigments such as TiO₂ added to the polymer to increase solar reflectance and to further reduce heat build-up. In addition to the color pigments, the substrate 300 includes stiffeners, such as calcium carbonate, to enhance the stiffness of the siding panel.

In an alternative embodiment of the cross section of an extrudate panel, as illustrated in FIG. 8, the heat build-up and color fade resistant polymer extrudate panel comprises a top, or face, polymer layer 400 that is thermally bonded to at least one additional polymer, backing, layer 500, wherein the panel exhibits an L* value of less than 40, a heat build-up of less than 50° F. and the ΔE of the panel does not exceed 1 color unit after five years of outdoor weathering. The susceptibility of various colors and siding layer compositions to heat build-up can be tested according to the procedures outlined at ASTM D4803.

Many different arrangements of the various components depicted, as well as components not shown, are possible without departing from the spirit and scope of the disclosed technology. Embodiments of the disclosed technology have been described with the intent to be illustrative rather than restrictive. Alternative embodiments will become apparent to those skilled in the art that do not depart from its scope. A skilled artisan may develop alternative means of implementing the aforementioned improvements without departing from the scope of the disclosed technology.

It will be understood that certain features and sub combinations are of utility and may be employed without reference to other features and sub combinations and are contemplated within the scope of the claims. Not all steps listed in the various figures need be carried out in the specific order described.

We claim:

1. A heat build-up resistant polymer extrudate panel, the panel comprising:
a top polymer layer;
an infrared light reflective capstock layer blended with at least one additive, the capstock layer disposed beneath the top layer; and
a substrate layer disposed beneath the capstock layer wherein the extrudate panel exhibits a predicted heat build-up of less than about 50° F.

2. The heat build-up resistant polymer extrudate panel of claim 1, wherein the top polymer layer is comprised of polyvinylidene difluoride.

3. The heat build-up resistant polymer extrudate panel of claim 1, wherein the top polymer layer has a thickness in the range of 0.0005 inches to 0.001 inches.

4. The heat build-up resistant polymer extrudate panel of claim 1, wherein the capstock layer comprises a polymer selected from the group of polyvinyl chloride, polypropylene, polyethylene polymers and copolymers and mixtures thereof.

5. The heat build-up resistant polymer extrudate panel of claim 1, wherein the at least one additive is chosen from a color pigment, a white pigment, a metallic pigment, or a combination of two of more thereof.

6. The heat build-up resistant polymer extrudate panel of claim 5, wherein the at least one additive is a TiO₂ pigment.

7. The heat build-up resistant polymer extrudate panel of claim 6, wherein, the TiO₂ pigment additive is greater than about 10 parts per hundred parts polyvinyl chloride.

8. The heat build-up resistant polymer extrudate panel of claim 1, wherein the at least one additive is selected from the group consisting of lubricants, tin stabilizers, impact modifiers, polyvinyl chloride and mixtures thereof.

9. The heat build-up resistant polymer extrudate panel of claim 1, wherein the capstock layer has a thickness in the range of from 0.003 to 0.005 inches.

10. The heat build-up resistant polymer extrudate panel of claim 1, wherein the capstock layer has total solar reflectance of at least 30%.

11. The heat build-up resistant polymer extrudate panel of claim 1, wherein the substrate layer is comprised of approximately 80% polyvinyl chloride.

12. The heat build-up resistant polymer extrudate panel of claim 11, wherein the substrate layer is further comprised of calcium carbonate to enhance panel stiffness.

13. The heat build-up resistant polymer extrudate panel of claim 1, wherein the panel has an L* value of less than about 50.

14. A color fade resistant polymer extrudate panel, the panel comprising:
a top polymer layer;
an infrared energy reflective capstock layer blended with at least one additive, the capstock layer disposed beneath the top polymer layer;
a substrate layer disposed beneath the capstock layer, and wherein the panel exhibits a predicted heat build-up of less than about 50° F. for an L* value of less than 40 and a ΔE not to exceed 1 in five years of outdoor weathering.

15. The color fade resistant polymer extrudate panel of claim 14, wherein the top polymer layer is selected from the group consisting of acrylic, acrylonitrile styrene acrylate, polyvinyl chloride and polyvinylidene difluoride.

16. The fade resistant polymer extrudate panel of claim 14, wherein the top polymer layer has a thickness in the range of from 0.0005 to 0.005 inches.

17. The fade resistant polymer extrudate panel of claim 14, wherein the infrared energy reflective capstock layer disposed beneath the top layer has a thickness in the range of from 0.003 to 0.005 inches.

18. The fade resistant polymer extrudate panel of claim 14, wherein the substrate layer has a thickness in the range of from 0.036 to 0.050 inches.

19. A heat build-up and color fade resistant polymer extrudate panel, the extrudate panel comprising:
a top polymer layer;
an infrared energy reflective capstock layer blended with at least one additive, the capstock layer disposed beneath the top polymer layer;
a substrate layer disposed beneath the capstock layer, and wherein the extrudate panel exhibits an L* value of less than 40 and a ΔE not to exceed 1 after five years of outdoor weathering.

20. The heat build-up and color fade resistant polymer extrudate panel of claim 21, wherein the capstock layer has a total solar reflectance of at least 30%.

21. The heat build-up and color fade resistant polymer extrudate panel of claim 21, wherein the panel exhibits a predicted heat build-up of less than about 50° F.

22. The heat build-up and color fade resistant polymer extrudate panel of claim 21, wherein the color change due to exposure to the environment does not exceed a ΔE of 1 color unit after five years of outdoor weathering, measured pursuant to ASTM D6864.

23. The heat build-up and color fade resistant polymer extrudate panel of claim 21, wherein the color change of the panel due to exposure to the environment does not exceed a ΔE of 2 color units after six or more years of outdoor weathering, measured pursuant to ASTM D6864.

24. A heat build-up and color fade resistant polymer extrudate panel, the extrudate panel comprising:
a first polymer layer disposed atop at least one additional polymer layer, wherein the panel exhibits an L* value of less than 40, a heat build-up of less than 50° F. and the ΔE of the panel does not exceed 1 color unit after five years of outdoor weathering.

25. The heat build-up and color fade resistant polymer extrudate panel of claim 24, wherein the heat build-up of the panel is measured pursuant to ASTM D4803 or ASTM WK47658.

26. The heat build-up and color fade resistant polymer extrudate panel of claim 24, wherein the L* value of the panel is determined pursuant to ASTM D2244.

27. The heat build-up and color fade resistant polymer extrudate panel of claim 24, wherein the ΔE of the panel is measured according to ASTM D6864.
